(19) United States
(12) Patent Application Publication
(10) Pub. No.: US 2003/0187920 A1
(43) Pub. Date: Oct. 2, 2003

(54) Communication management system

(76) Inventor: Tejaswi Redkar, Sunnyvale, CA (US)

Correspondence Address: Erik Metzger, IntellectualArts, 360 Guerrero St. #215, San Francisco, CA, 94103, US

(21) Appl. No.: 10/320,039

(22) Filed: Dec. 16, 2002

Related U.S. Application Data
(60) Provisional application No. 60/368,559, filed on Apr. 1, 2002.

(51) Int. Cl. G06F 15/16

(52) U.S. Cl. 709/203

(57) ABSTRACT

The invention described herein pertains to residential and telemetry gateway networks. More particularly, the invention pertains to managing communication between service providers and residential and/or telemetry gateways by providing a communication management system that is independent of the vendor of gateway used.

### CLAIM OF PRIORITY

This non-provisional patent application claims the benefit under 35 U.S.C. §119(e) from a prior provisional application serial No. 60/368559, filed on Apr. 1, 2002.

### FIELD OF THE INVENTION

The invention relates to the field of residential and telemetry gateways. More particularly, the invention provides a communication management system to support collecting and storing real-time data and managing configuration information of heterogeneous and/or multi-vendor gateways.

### BACKGROUND

As use of the Internet grows and becomes more ubiquitous in everyday life, users have begun to rely on it for more than mere personal computing. With the advent of web-based services, such as security monitoring, home appliance control, and factory automation, numerous residential and telemetry gateway providers have emerged in the marketplace. Many gateway vendors require proprietary communication protocols and interfaces in order to use their gateways.

Residential and telemetry gateways have appeared in homes and businesses to allow service providers to control a range of functions, including power utilities, security service, manufacturing automation, building function, and entertainment services. Many of the services provided via gateways are provided by a single service provider, but it is more often the case that services are provided by a number of different service providers. Furthermore, many homes and businesses use gateways for various web-based services from the same gateway vendor, but it is more frequently the case that gateways from numerous vendors are used in the same home or business.

It becomes increasingly difficult for service providers to support the growing number of gateways, since gateway vendors may require support for proprietary communication protocols and information management interfaces in order to communicate with the gateway. Similarly, end-users may be limited in the types of services available to them by whether a particular service provider supports a particular gateway vendor.

Service providers incur great cost and performance penalties for supporting many gateways from numerous gateway vendors, because of the gateway-specific interfaces and protocols that must be used to communicate with each gateway. For example, a service provider may have to communicate with a security-monitoring device via a gateway by one vendor and immediately monitor a residential thermostat of the same client via a gateway made by another vendor. Not only must the service provider support the communication software necessary to retrieve data and control these service functions, but they also must load and access the software each time they communicate with devices controlled by different gateways. Therefore, cost and performance are effected accordingly.

FIG. 1 illustrates a prior art multi-vendor gateway system. In FIG. 1, several residential and telemetry gateways are used to access various services through a communication management system. The communication management system illustrated in FIG. 1 may be composed of a number of software modules to allow service providers, such as an internet service provider (ISP), to access data through a user's gateway, such as security information, or to allow user's gateway(s) to communicate with the service providers, or to allow for the storage of configuration information pertinent to a user's configuration or user preferences.

The communication management system of FIG. 1 may consist of various software modules and/or computer system hardware to provide for communication between service providers and the system gateways. However, prior art communication management systems may contain vendor-specific modules and therefore require service providers to support a number of communication management systems from a number of gateway vendors, each having different communication protocols, interfaces, and architectures.

Specifically, the system illustrated in FIG. 1 consists of multi-vendor gateways performing different functions. The gateways illustrated in FIG. 1 communicate with service providers through a communication management system consisting of gateway vendor-specific software components performing functions specific to a particular gateway vendor.

Supporting vendor-specific communication management system components, such as those illustrated in FIG. 1, increases service provider costs as well as impedes the adoption of web-based services by the increasing cost and decreasing performance of the communication management system.

### BRIEF DESCRIPTION OF THE DRAWINGS

FIG. 1 illustrates a prior art communication management system.

FIG. 2 illustrates a gateway and the devices, functions, and services it may support.

FIG. 3 illustrates a communication management system according to one embodiment of the invention.

FIG. 4 illustrates the operation of an real-time communication manager according to one embodiment of the invention.

FIG. 5 illustrates a system in which one embodiment of the invention may be used.

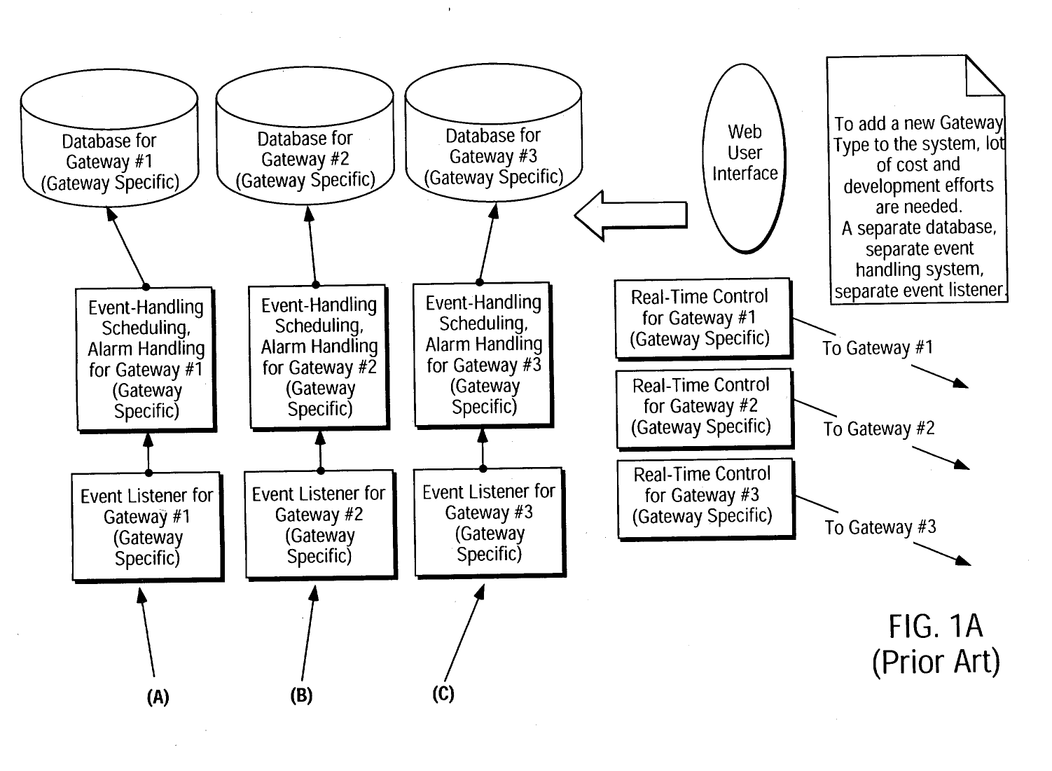

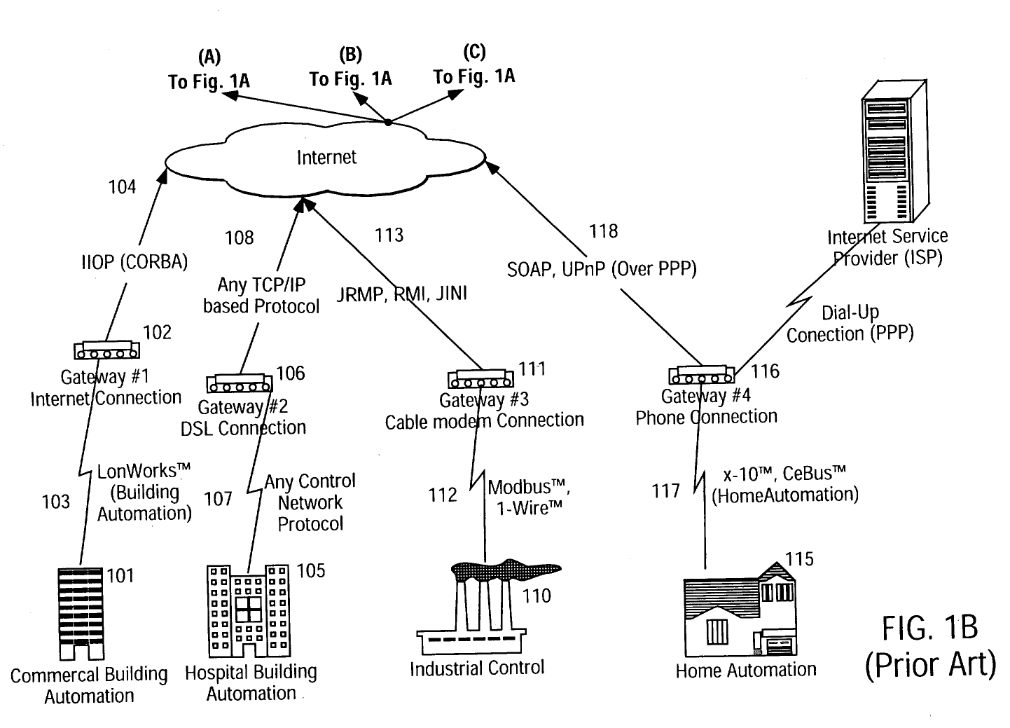

### DETAILED DESCRIPTION

The invention described herein pertains to residential and telemetry gateway networks. More particularly, the invention pertains to managing communication between service providers and residential and/or telemetry gateways by providing a communication management system that is independent of the vendor of the gateway used.

The term “vendor”, to the extent it is used herein to refer to a gateway or gateways, shall mean a gateway manufacturer, designer, wholesaler, and/or retailer. Furthermore, the term “type”, to the extent it is used herein to refer to a gateway or gateways, shall refer to the function(s) provided by a gateway.

At least one embodiment of the invention supports functions, services, and communication interfaces between service providers and a number of different types of gateways or from a number of different gateway vendors, such that service providers need not provide gateway vendor-specific support for each gateway or gateway vendor. Instead, a service provider need only support a gateway vendor-independent gateway communication management system for collecting real-time data and managing configuration information of gateways from a number of vendors. Furthermore, the invention alleviates the need for special hardware or software to be installed by a gateway user in order to support the addition or subtraction of other gateways.

More specifically, at least one embodiment of the invention provides support for of multi-vendor gateways by supporting a communication management system consisting of a set of functions, services, and interfaces, such as:

Real-time data retrieval from multi-vendor/type gateways and communicating real-time data within and without the communication management system.

Real-time control of multi-vendor/type gateways that may act as a proxy in controlling devices, services, and/or appliances.

Plug-n-Play functions for dynamically adding support for new gateways at run-time without making significant modifications to the communication management system.

Scheduling management for managing schedules of functions provided through the gateway.

Web services interface for interfacing with services, such as:

1. Service integration systems, such as Enterprise Resource Planning (ERP) systems, reporting systems, billing systems, etc.

2. Customized services, such as energy management, power management, home automation, and security systems.

3. Other services requiring access to data stored in the communication management system database.

Transmission Control Protocol/Internet Protocol (TCP/IP) communication capabilities.

Worldwide web (WWW) based interface capabilities.

Alarm management for handling and forwarding of alarms or special conditions arising from multi-vendor gateways or the communication management system.

Event management for handling events arising from multi-vendor gateways.

Configuration management for retrieving, downloading, and storing configuration data of multi-vendor gateways.

Database for storing configuration and archived data used accessed by the service provider or multi-vendor gateways.

Configuration and operational information pertaining to multi-vendor gateways.

Configuration and operational information pertaining to services supported by multi-vendor gateways.

Configuration and operational information pertaining to devices and appliances supported by multi-vendor gateways.

Scheduling information pertaining to multi-vendor gateways.

Scheduling information pertaining to devices and appliances supported by multi-vendor gateways.

Different embodiments of the invention may support additional or fewer functions, services, and interfaces than described above, depending on the particular needs of the gateway(s) supported.

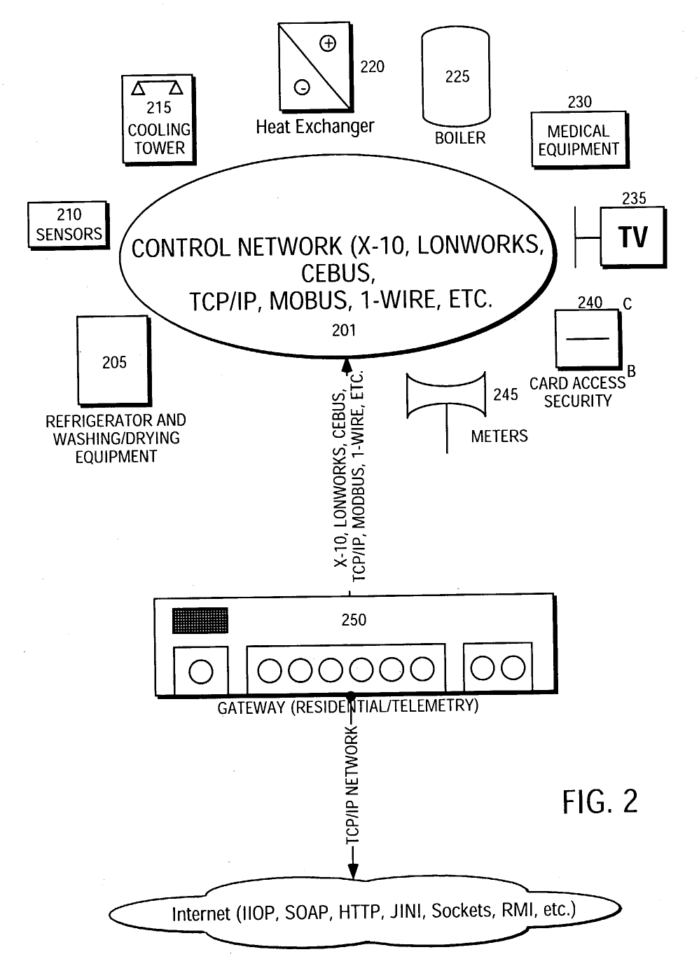

FIG. 2 illustrates a residential or telemetry gateway and the devices, functions, and services it may support. Using a number of different network interface protocols 201, the gateway 250 can be used to control functions in residential or industrial environments, including refrigerator and washer/dryer equipment 205, sensor devices 210, cooling towers 215, heat exchangers 220, boilers 225, medical equipment 230, television 235, security systems 240, and utility meters 245. Other services, functions, and devices may be controlled by the gateway illustrated in FIG. 2 or those controlled by a number of gateways, including those from different gateway vendors.

A Gateway Vendor-Independent Communication Management System

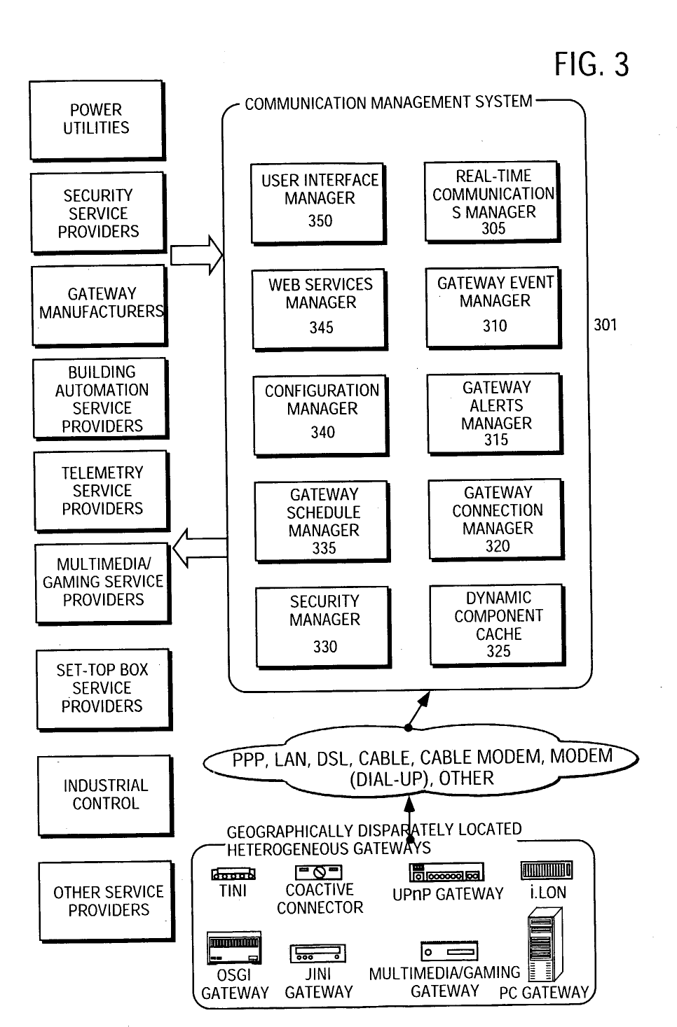

FIG. 3 illustrates a communication management system according to one embodiment of the invention. The communication management system illustrated in FIG. 3 includes a real-time communications manager (RTCM), a gateway events manager (GEM), a gateway alert manager (GAM), a gateway connection manager (GCM), a dynamic component cache (DCC), a security manager (SM), a gateway schedule manager (GSM), a configuration manager (CM), a web services manager (WSM), and a user interface manager (UIM), each of which are gateway vendor-independent.

In one embodiment the communication management system is implemented by instructions stored on a machine-readable medium, which when executed by a machine, cause the machine to perform methods (software). In another embodiment, the communication management system is implemented with hardware logic using complimentary metal-oxide-semiconductor (CMOS) circuitry. In yet another embodiment the communication management system is implemented using a combination of software and CMOS circuitry.

Gateway Alerts Manager

The gateway alerts manager (GAM) is responsible for forwarding alerts to an end-user pertaining to various conditions that may have occurred in a gateway or in the communication management system. Alerts may be forwarded to the end-user in various way, including email, pager, cell phone notification, fax, and/or instant messaging.

Furthermore, notification lists for a particular alert may be stored in a database, as well as the forwarding means (email, pager, instant message, etc.).

The GAM can maintain a list of alert handlers in a database for forwarding the alerts. For example, an email handler may forward alerts in the form of email.

Additional alert handlers can be added to the system dynamically by adding the handler to the dynamic component cache (DCC), without recompiling the communication management system.

User Interface Manager

The user interface manager (UIM) may support any or all of the functionality supported by the web services manager (WSM). Furthermore, the UIM may be used to configure the communication management system using a web-based user interface. The UIM may be used to configure the communication management system using a stand-alone user interface, such as a .NET application, a Java™ application, or a Windows® application.

Real-Time Communications Manager

The real-time communication manager (RTCM) is responsible for functions, such as retrieving and setting real-time data in a gateway, dynamic instantiation of gateway-specific real-time communication at run-time based on the type of gateway in use, sending real-time control commands to the gateway, sending real-time data-retrieval commands to the gateway, retrieving state information and controlling the state of services supported by the gateway, retrieving state information and controlling the state of devices supported by the gateway, retrieving state information and controlling the state of the gateway, and communicating with the GCM to initiate or end a connection to a gateway. The RTCM may support fewer or more functions than those described above, depending on the needs of a particular gateway or number of gateways.

In at least one embodiment, the RTCM will communicate with the GCM when the gateway has a dial-up (telephone) connection. The RTCM can also ask for a connection to the gateway by providing the GCM with a phone number and identification of the gateway. Gateways can be represented in the system by a unique identifier gateway identification code, or similar means. In the case of a broadband (Ethernet, Cable Modem, DSL, etc.) connection, however, it may not be necessary for the RTCM to communicate with the GCM.

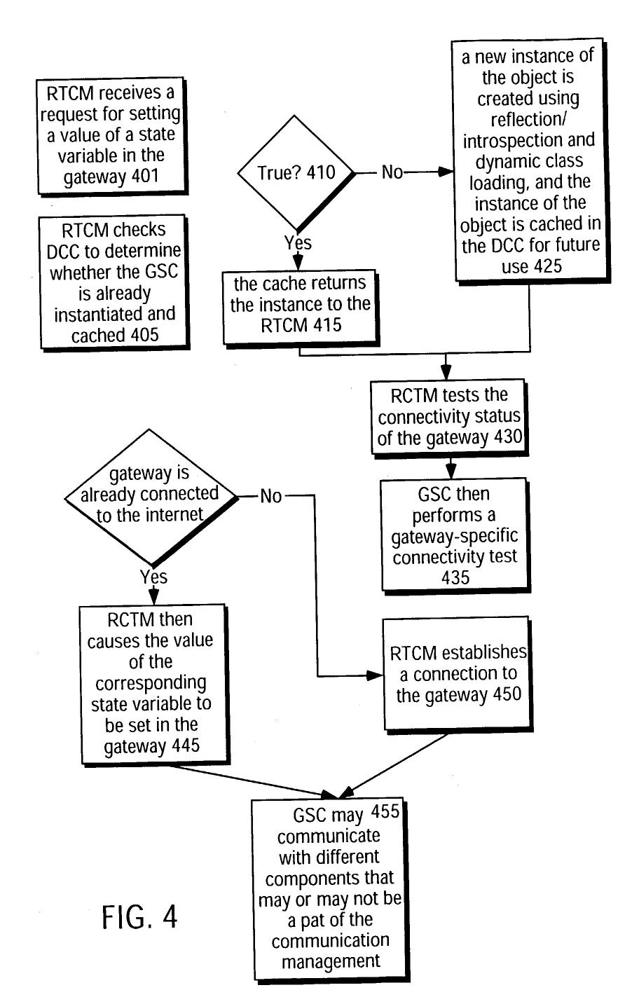

FIG. 4 is a flow diagram illustrating the operation of the RTCM according to one embodiment of the invention. Referring to FIG. 4, the RTCM receives a request for setting a value of a state variable in the gateway 401. The request may contain information informing the RTCM as to whether the gateway is configured for dial-up or a broadband access. The RTCM then checks the dynamic component cache (DCC) to determine whether the gateway specific component (GSC) is already instantiated and cached 405. If the GSC is already present in the cache 410, the cache returns the instance to the RTCM 415. If the GSC is not already present in the cache, a new instance of the object is created using reflection/introspection and dynamic class loading, and the instance of the object is cached in the DCC for future use 425. Furthermore, the DCC may serialize the instance to a file, database, or other data storage type.

Once the RTCM acquires the instance of the GSC from the DCC, RTCM tests the connectivity status of the gateway 430. The GSC then performs a gateway-specific connectivity test 435. If the gateway is already connected 440 to the Internet, the RTCM then causes the value of the corresponding state variable to be set in the gateway 445. Otherwise, the RTCM establishes a connection to the gateway 450.

The GSC in turn may communicate 455 with different components that may or may not be a part of the communication management system. For example, the GSC may query a domain name server (DNS) to get an Internet protocol (IP) address of the gateway before communicating with the gateway. Alternatively, the GSC may instantiate a Universal Plug and Play (UPnP) control point to change the state of a state variable of a UPnP service running on or managed by the gateway, thereby making installation of a GSC into the communication management system flexible and compatible with third-party components.

One example of integrating a third-party component into a communication management system in accordance with one embodiment of the invention involves a scenario in which a gateway vendor has developed a software application programming interface (API) for communicating with a particular gateway. To add the gateway to the communication management system, the service provider may develop a software wrapper around the gateway manufacturer's API that conforms to the API of the communication management system and store the wrapper component in the DCC. Doing so alleviates need for a service provider to invest in a new software infrastructure to manage real-time communication with the gateway.

Finally, if the gateway supports a dial-up connection and it is not currently connected to the Internet, the RTCM may request, either synchronously or asynchronously, a connection for the gateway to the gateway connection manager (GCM). The GCM may interpret the connection-type of the gateway and establish an Internet connection with the gateway. In one example, the GCM may interpret the RTCM's request as indicating that the gateway supports a point-to-point (PPP) connection. In that case, the GCM may initiate a PPP connection to the gateway. The GCM may similarly communicate with third party software modules, such as a shoulder-tap server to initiate and disconnect gateway connections.

Once the connection is established with the gateway, the RTCM may perform similar functions described above and illustrated in FIG. 4.

Gateway Events Manager

In general, the gateway events manager (GEM) is responsible for detecting, subscribing, responding, and otherwise acting on events sent from a gateways or group of gateways. In one embodiment of the invention, the GEM consists of at least four sub-components, including a gateway specific event listener (GSEL), a message transformer (MT), a gateway independent event handler (GIEH), and an event handler (EH).

The GEM is responsible for detecting gateway-specific events and forwarding them to the appropriate MT. For example, a UPnP event listener may subscribe to a particular state variable event corresponding to a gateway when the state variable changes in a user's device connected to a gateway, and the gateway sends an event notification to its subscribers. The UPnP event listener then forwards the event to an MT to transform the message into gateway-independent message format that can be interpreted by the communication management system.

The MT may exist in various forms, including a separate server process executing on a separate computer system, an API, or part of the GSEL. For example, the MT may be an enterprise java bean, a COM+ dynamic link library, .NET assembly, a process on a remote server, or part of the GSEL code base. Furthermore, the MT may be a cluster of processes executing on one or more computer systems using a remote interface. However, a feature of the MT, according to at least one embodiment, is that its input is a gateway-specific event and its output is a gateway-independent event that can be interpreted by the communication management system. The MT forwards the transformed event to GIEH.

In general, the GIEH is responsible for processing an event and taking an appropriate action depending on the configuration of the event in the database. Actions that the GIEH may take, include delegating the execution of the event to one or more event handlers, forwarding the event to the GAM, or storing the event in the database. The action delegated by the GIEH to an EH may depend on the configuration of the event in the database and/or the capabilities of the EH.

For example, in one embodiment of the invention, an EH may be capable of forwarding an event to subscribers of the event. In that case, the EH must be capable of maintaining the subscribers list for the event and forwarding the event to the appropriate subscribers in an efficient manner. In order to perform these tasks, an EH may queue all the events corresponding to the same subscriber, and then forward them to the subscriber in one network cycle, thus reducing the network traffic. However, in other embodiments, the EH may perform the tasks in other manners depending on the efficiency requirements of the communication management system and tasks to be performed.

For example, the EH may be responsible for setting a state variable managed by a gateway when an event occurs and sending an alert to a list of users in the form of an email, page, fax, phone call, etc. If a gas leakage detector connected to the gateway detects a gas leak, for example, the detector may indicate a leakage by sending a signal thorough the gateway, close the valve that leaked the gas, and inform the proper security personnel via a pager notification.

When the gas-leakage event is detected by the GIEH, the GIEH may instantiate an EH that can cause a gas valve to be closed (e.g., change the state variable of the valve to the shutdown position) and forward the event to the GAM in order to notify proper authorities of the gas leak.

An EH is capable of executing an action based on the type of event detected. For example, an EH can be used to set a state variable for a service provided through a gateway or forward a list of subscribers of an event to a database. Although an EH may be developed by third parties, including a service provider, gateway vendor, or independent developer, a developer does not need specific knowledge of the communication management system. Instead, a developer need may only need to be familiar with an API associated with the communication management system.

Furthermore, an EH can be added to the communication management system at run-time by loading the EH into the DCC without recompiling, restarting, or otherwise reinitializing the communication management system.

Gateway Connection Manager

In general, the gateway connection manager (GCM) is responsible for managing connections to gateways from a service provider or service providers. Specifically, the GCM can be used to maintain a record of gateways connected to a service provider at any particular time. The GCM may test the connectivity status of a gateway by issuing an Internet control message protocol (ICMP) message (PING). Furthermore, the GCM may be used to disconnect a dial-up connection to gateways, initiate a Point-To-Point (PPP) connection to gateways, interface with a PPP server to manage the connectivity to a gateways, interface with third-party modules, such as shoulder-tap software for initiating and disconnecting a connection to gateways, and forward connection requests to third-party modules to connect or disconnecting the gateways.

The GCM may perform other functions than those previously described, depending on the needs of the communication management system. In order to perform these various functions, the GCM may use an interface, such as an API, a library, or a separate server or a cluster or servers.

Dynamic Component Cache

In general, the dynamic component cache (DCC) instantiates and caches instances of dynamically-loaded components within the communication management system. Furthermore, the DCC may serialize instances into a database in order for a service provider or a third-party to access them. Reflection and introspection may be performed on fields, such as the name of the component and/or the component's code base address, in order to initialize the component and store it in the DCC. A component can be loaded from locations, such as a local code base or a remote location depending on where the code base address.

The DCC can be an in-memory cache or a in separate server executing a different process. In one embodiment, the DCC helps in improving performance of the communication management system by managing object instances. This is because reflection can involve a lot of overhead and the component may have to be loaded to the DCC from a code base resulting in a significant performance decrease. The DCC can compensate for performance losses by caching dynamically loaded components as well as enabling the addition of gateways and/or EH's at run-time without incurring significant performance degradation.

Security Manager

In general, the security manager (SM) is responsible for managing security of the communication management system. In one embodiment, the SM manages security by authenticating user accesses to date within the communication management system, and authenticating user accesses to a gateway, among other things. User access can be authenticated in various ways, including user identification number matching.

Gateway Schedule Manager

Generally, the gateway schedule manager (GSM) is responsible for functions, such as managing commands scheduled to be sent to a gateway or gateways, instantiating scheduling objects for a gateway or gateways, and delegating actual schedule execution responsibility to scheduling objects in order to enable the addition of new scheduling objects at run time.

The GSM also enables developers, such as a service provider, gateway manufacturers, or third parties to develop scheduling handlers for any particular schedule. There are typically three types of schedules that developers support: key-based schedules, interval-based, and once-execution schedules with retries.

Key-based schedules are triggered by a key in the schedule event, and are typically used in situations in which a schedule needs to be executed only upon the occurrence of a particular event from a gateway.

For example, a service provider may want to download configuration information to a gateway when the gateway connects to the communication management system on Feb. 25, 2002 between 1:00 am and 3:00 am. The service provider can be configured to schedule the download with a scheduling object when the gateway connects to the communication management system using an “online” event.

In one embodiment, the GSM detects the “online” event and parses scheduling information stored in the communication management system database to match the key with the time range. If the parse returns a matching record, the GSM instantiates a scheduling object based upon scheduling information from the DCC and invokes the appropriate method in the scheduling object to handle the schedule. The scheduling object will then download the configuration information to the gateway.

Interval-based schedules are triggered upon some start time and continue while an end time has not yet passed. Furthermore, the GSM may monitor a scheduling information database table in order to detect an interval-based schedule start event, and the interval-based schedule can be executed on a continuous basis until an end-time is reached.

In one embodiment, an interval-based schedule uses a SCHEDULE_INCREMENT field in order to inform the GSM of an interval at which the schedule needs to be executed. The GSM automatically updates a NEXT_SCHEDULE_DATE field in the communication management system database table by issuing a SCHEDULE_INCREMENT command to the NEXT_SCHEDULE_DATE field or the FIRST₁₃ SCHEDULE_DATE if the schedule is being executing for the first time.

Execute-once schedules are triggered when a start time is passed and an end time has not passed and the schedule is to be executed only once. The GSM may monitor the scheduling information database table for the execute-once condition and respond accordingly after the condition is detected.

In one embodiment, an execute-once schedule uses a NUMBER_OF_RETRIES field to inform the GSM of whether and how many times a schedule should be retried. Particularly, the GSM interprets a SCHEDULE_INCREMENT command as a retry interval between two failed schedule executions. The SCHEDULE_INCREMENT command and the NUMBER_OF_RETRIES field indicate the intervals at which a schedule is to be retried.

The GSM automatically updates the NEXT_SCHEDULE_DATE field in the communication management system database table by issuing a SCHEDULE_INCREMENT command to the NEXT_SCHEDULE_DATE if the NUMBER_OF_RETRIES field is a positive integer. Similarly, the GSM will decrement the NUMBER_OF_RETRIES field after a failed schedule execution. If the NUMBER_OF_RETRIES field or the SCHEDULE_INCREMENT command are not supplied to the GSM, then GSM does not attempt to retry the execution of the schedule.

Configuration Manager

In general, the configuration manager (CM) is responsible for remotely configuring gateways, sending configuration updates to gateways, retrieving configuration information from gateways, and retrieving configuration changes from the gateways. Furthermore, the CM can discover new gateways on a network, publish gateway addresses over the network, and/or detect configuration and registration events on the network sent or published by the gateways.

The CM can be implemented in various ways, such as an API, independent server, or a part of the gateway events manager. Furthermore, a configuration event may be handled differently from other gateway events due to the fact that configuration events may not require information about the gateway to be present in the communication management system database.

In one embodiment of the invention, the CM consists of three components: a gateway-specific configuration event listener (GSCEL), a gateway-independent configuration handler (GICH), and a gateway-specific configuration message transformer (CMT).

In one example in which the embodiment may be used, a UPnP listener may detect a service registration event from a UPnP gateway, and the GSCEL may forward a configuration event to the CMT. The CMT converts a gateway-specific configuration event, such as the service registration event, to a gateway-independent configuration event, and the CMT forwards the gateway-independent configuration event to GICH.

The GICH may then store the configuration event information in a database, communicate with a gateway to retrieve further configuration information, send configuration updates to gateways, retrieve configuration information from the gateways, and/or retrieve configuration changes from the gateways.

In another example, a UPnP gateway added to a network may locate the address of a UPnP-specific configuration event listener and send a registration event to it. The UPnP configuration event listener may then forward the configuration event to a UPnP-specific CMT, and the UPnP-specific CMT may convert the UPnP specific configuration event to a gateway-independent configuration message and then forward the gateway-independent configuration message to a GICH.

The GICH may then store the gateway independent configuration information into a database or instantiate the UPnP-specific configuration handler stored in the dynamic component cache (DCC). The UPnP-specific configuration handler may then retrieve further information about a gateway, such as services supported by the gateway, by querying the gateway and storing information about the gateway and corresponding services into the database.

Web Services Manager

The web services manager (WSM) is a web services interface for interfacing with web users or with third-party software and/or hardware. For example, the WSM provides a platform-independent interface for making remote procedure calls. The WSM can be used by third-party software/hardware for functions, such as interacting with the communication management system, retrieving information stored in the system, sending information to the system, accessing information about multi-vendor gateways in a uniform manner, and interacting with multi-vendor gateways in real-time without determining the vendor of gateway.

For example, a service provider may interface with a number of different gateways from a number of different vendors. Some gateways may provide automatic meter reading, while some may monitor the temperature of reactors in a chemical plant. In one embodiment of the invention, the service provider can obtain real-time and archived values of the meter reading as well as the temperature values in the reactor from the communication management system without having to be aware of the vendor of gateway with which it is communicating with, thereby enabling transparent interaction with multi-vendor gateways.

In another example, a service provider or third party may provide energy management capabilities, such as those associated with silicon energy, including a user interface and a method for the calculation of energy-related data. The service provider may use the web services interface provided by one embodiment of the invention to retrieve real-time or archived data from the communication management system to perform the energy-related calculations and/or transformations.

In the above example, the service provider need not be concerned with the type of gateways or devices the energy management system supports. Furthermore, if the service provider also supports a user interface and a method for calculating for telemetry data, for example, the service provider may use the web services interface associated with at least embodiment to retrieve real-time or archived data to perform telemetry-related calculations and/or transformations.

Again, the service provider or third-party does not have to be concerned with the vendor of gateway or device required to retrieve data. Instead, the service provider or third-party can use a platform-independent web service interface, provided in at least one embodiment of the invention, to retrieve data and apply service-specific calculations and/or transformations to the data. Accordingly, the service provider or third-party can save time and money in supporting these services, because the service provider or third party does not have to develop hardware and/or software to support vendor-specific gateways.

In addition to those previously mentioned, the WSM may provide other functions, including service provider functions, functions for adding/removing/updating gateways, adding/removing/updating schedules, adding/removing/updating users, retrieving archived data, retrieving real-time data from gateways, configuring event handling, configuring alert handling, adding/removing/updating new gateway-specific real-time components, adding/removing/updating new schedule handlers, and adding/removing/updating new gateway specific event handlers, adding/removing/updating new gateway specific configuration handlers, supporting diagnostics information, supporting connective/administrative functions, and adding/removing/updating service provider accounts. Other or fewer functions may be supported by the WSM in different embodiments of the invention.

### A System

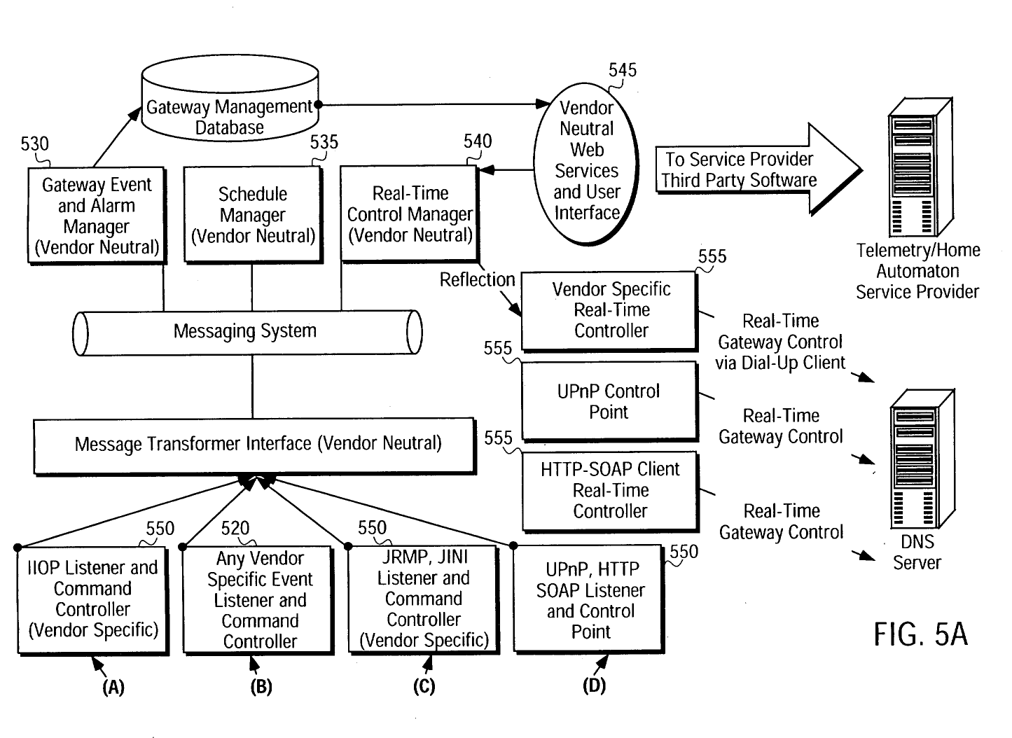

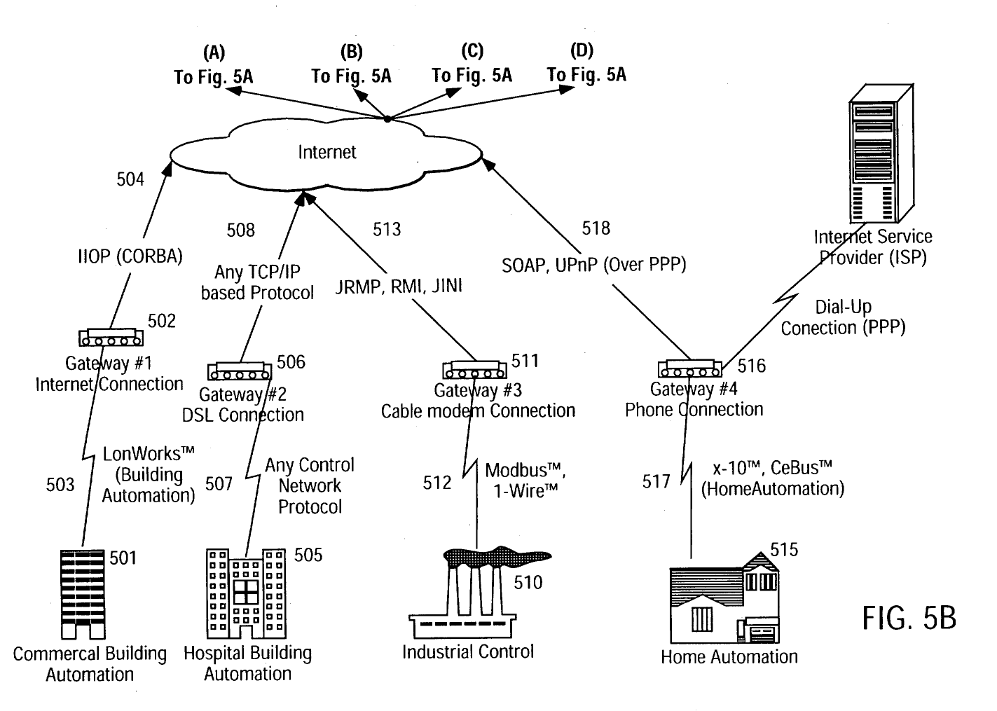

FIG. 5 illustrates a system in which one embodiment of the invention may be used.

The system illustrated in FIG. 5 consists of multi-vendor gateways performing various functions. The gateway and service providers of FIG. 5 communicate through a communication management system consisting of gateway vendor-independent as well as gateway vendor-specific software modules. For example, in FIG. 5, commercial building automation 501, hospital building management automation 505, industrial control 510, and home automation 515 are all managed through various vendor-specific gateways 502, 506, 511, 516, using various network protocols 503, 507, 512, 517 that also may be vendor-specific. Furthermore, the gateways communicate with service providers through the Internet using different Internet protocols 504, 508, 513, 518 that may be vendor-specific.

The communication management system of FIG. 5 consists of gateway vendor-independent modules, including an event listener and command controller (ELCC) 520, a message transformer interface (MTI) 525, a gateway event and alarm manager (GEAM) 530, a schedule manager (SM) 535, a real-time control manager (RTCM) 540, and a web services and user interface (WSUI) 545. The communication management system of FIG. 5 also contains some gateway vendor-specific modules, including vendor-specific listener and command controllers 550 and vendor-specific domain name server (DNS) access controllers 555.

While this invention has been described with reference to illustrative embodiments, this description is not intended to be construed in a limiting sense. Various modifications of the illustrative embodiments, as well as other embodiments, which are apparent to persons skilled in the art to which the invention pertains are deemed to lie within the spirit and scope of the invention.

What is claimed is:

1. A machine-readable medium having stored thereon a set of instructions, which when executed by a machine cause said machine to perform a method comprising:
coupling a service provider with multi-type gateways;
communicating information between said service provider and said multi-type gateways using functions that are independent of a vendor of any of said multi-type gateways;
managing communication between said service provider and said multi-type gateways.

2. The machine-readable medium of claim 1 wherein said managing comprises retrieval of real-time data from said multi-type gateways.

3. The machine-readable medium of claim 2 wherein said communicating comprises communicating said real-time data within a communication management system (CMS).

4. The machine-readable medium of claim 3 wherein said communicating further comprises communicating said real-time data to receivers outside of said CMS.

5. The machine-readable medium of claim 1 wherein said managing comprises performing functions to support coupling additional gateways to said service provider dynamically.

6. The machine-readable medium of claim 1 wherein said managing comprises performing functions to support de-coupling of said multi-type gateways and said additional gateways from said service provider dynamically.

7. The machine-readable medium of claim 1 wherein said managing comprises scheduling events supported by said multi-type gateways and said additional gateways.

8. The machine-readable medium of claim 1 further comprising managing communication between a plurality of service providers of a plurality of types and a plurality of gateways of a plurality of types.

9. A system comprising:
a service provider coupled to a plurality of gateways;
a communication management system (CMS) to manage communication between said plurality of gateways and said service provider, said CMS comprising a plurality of gateway vendor-independent units to perform a plurality of communication management functions between said plurality of gateways and said service provider.

10. The system of claim 9 wherein said CMS comprises a user interface manager, said user interface manager being gateway vendor-independent.

11. The system of claim 10 wherein said CMS comprises a real-time communications manager, said real-time communications manager being gateway vendor-independent.

12. The system of claim 11 wherein said CMS comprises a gateway event manager, said gateway event manager being gateway vendor-independent.

13. The system of claim 12 wherein said CMS comprises a configuration manager, said configuration manager being gateway vendor-independent.

14. The system of claim 13 wherein said CMS comprises a gateway alerts manager, said gateway alerts manager being gateway vendor-independent.

15. The system of claim 14 wherein said CMS comprises a web services manager, said web services manager being gateway vendor-independent.

16. The system of claim 15 wherein said CMS comprises a gateway schedule manager, said gateway schedule manager being gateway vendor-independent.

17. The system of claim 16 wherein said CMS comprises a gateway connection manager, said gateway connection manager being gateway vendor-independent.

18. The system of claim 17 wherein said CMS comprises a security manager, said security manager being gateway vendor-independent.

19. The system of claim 18 wherein said CMS comprises a dynamic component cache, said dynamic component cache being gateway vendor-independent.

20. The system of claim 9 further comprising a plurality of gateways from a plurality of vendors;

21. A method comprising:
managing communication between a service provider and a gateway, said managing comprising performing a function that is independent of a vendor of the gateway if a corresponding gateway-specific component is not instantiated;
exchanging data between said service provider and said gateway.

22. The method of claim 21 wherein said managing comprises searching a dynamic display cache to determine whether said gateway-specific component is instantiated.

23. The method of claim 22 wherein said managing comprises managing a user interface between said service provide and said gateway.

24. The method of claim 22 wherein said managing comprises managing real-time communications between said service provide and said gateway.

25. The method of claim 22 wherein said managing comprises managing a gateway event.

26. The method claim 22 wherein said managing comprises managing a configuration of said gateway.

27. The method of claim 21 wherein said managing comprises managing alerts from said gateway.

28. The method of claim 21 wherein said managing comprises managing web services available to said gateway from said service provider.

29. The method of claim 21 wherein said managing comprises managing a schedule of events corresponding to the gateway.

30. The method of claim 21 wherein said managing comprises managing a connection between said service provide and said gateway.

31. The method of claim 21 wherein said managing comprises managing security between said service provide and said gateway.

32. An apparatus comprising:
a plurality of gateway type-independent functional units comprising:
a user interface management unit;
a real-time communications management unit;
a gateway event management unit;
a configuration management unit;
a gateway alerts management unit;
a web services management unit;
a gateway schedule management unit;
a gateway connection management unit;
a security management unit;
a dynamic component cache.

33. A system comprising:
a plurality of functional units to perform a plurality of communication management functions between a service provider and a plurality of gateways that are independent of a plurality of proprietary gateway software interfaces from a plurality of gateway vendors, said plurality of functional units comprising:
a unit to manage a user interface;
a unit to manage real-time communications;
a unit to manage a gateway event;
a unit to manage a configuration;
a unit to manage gateway alerts;
a unit to manage web services;
a unit to manage gateway scheduling;
a unit to manage a gateway connection;
a unit to manage security;
a dynamic component cache.

34. The system of claim 33 wherein said plurality of functional units are software functions.

35. The system of claim 33 wherein said plurality of functional units are computer system hardware units.

36. The system of claim 33 wherein said plurality of functional units are partially computer system hardware units and partially software functions.
